(19) United States
(12) Patent Application Publication
(10) Pub. No.: US 2026/0307020 A1
(43) Pub. Date: Oct. 8, 2026

(54) ION EXCHANGE MEMBRANE

(71) Applicant: Khalifa University of Science and Technology, Abu Dhabi (AE)

(72) Inventors: Emad Alhseinat, Abu Dhabi (AE); Randa Ibrahim Abdelrehim, Abu Dhabi (AE)

(21) Appl. No.: 19/170,458

(22) Filed: Apr. 4, 2025

(51) Int. Cl. B01D 71/68; B01D 61/46; B01D 67/00; B01D 69/14; B01D 71/02

(52) U.S. Cl. CPC B01D 71/68; B01D 61/463; B01D 67/0011; B01D 69/148; B01D 71/02; B01D 2323/2181; B01D 2323/219

(57) ABSTRACT

A membrane includes sulfonated polyethersulfone; humic acid; and a MXene material, wherein a weight ratio of humic acid to sulfonated polyethersulfone ranges from about 20:100 to about 30:100, and a weight ratio of the MXene material to sulfonated polyethersulfone ranges from about 15:100 to about 25:100. A method for forming a membrane includes mixing a solvent, sulfonated polyethersulfone, and humic acid to form a first mixture; adding a MXene material to the first mixture to form a second mixture; casting the second mixture; and evaporating the solvent to form a product membrane.

### TECHNICAL FIELD

The subject matter disclosed herein relates to membranes and more particularly to ion exchange membranes and utilization of ion exchange membranes for energy harvesting/generation, desalination, and ion recovery. The present invention further relates to methods for forming such membranes.

### BACKGROUND

Ion exchange membranes (IEMs) are playing an increasingly important role in various applications, with the diverse uses of ion exchange membranes expanding year after year. These ion exchange membranes are polymeric films with charged ionic functional groups that allow the transport of oppositely charged species (counterions) while retaining like-charged ions (co-ions). The significance of membranes in the advancement of operations such as energy harvesting cannot be overstated. One example of an energy harvesting application is reverse electrodialysis (RED). Reverse electrodialysis is used for harnessing energy from the Gibbs free energy of mixing under a salinity gradient. However, achieving optimal selectivity, high performance, and cost-effectiveness remains a key challenge hindering the commercialization of reverse electrodialysis units.

### SUMMARY

According to one aspect, a membrane includes: sulfonated polyethersulfone; humic acid; and a MXene material, wherein a weight ratio of humic acid to sulfonated polyethersulfone ranges from about 20:100 to about 30:100, and a weight ratio of the MXene material to sulfonated polyethersulfone ranges from about 15:100 to about 25:100.

According to another aspect, a method for forming a membrane includes: mixing a solvent, sulfonated polyethersulfone, and humic acid to form a first mixture; adding a MXene material to the first mixture to form a second mixture; casting the second mixture; and evaporating the solvent to form a product membrane.

According to another aspect, a reverse electrodialysis system includes: an anode; a cathode; one or more anion exchange membranes; and one or more cation exchange membranes, the one or more cation exchange membranes including a plurality of sulfonated polymers, humic acid, and a MXene material, wherein a weight ratio of humic acid to the plurality of sulfonated polymers in the one or more cation exchange membranes ranges from about 20:100 to about 30:100.

### BRIEF DESCRIPTION OF THE DRAWINGS

FIG. 1 illustrates a method for forming a membrane, according to some embodiments.

FIG. 2A illustrates a reverse electrodialysis system, according to some embodiments.

FIG. 2B illustrates an electrodialysis system, according to some embodiments.

FIG. 3 illustrates interactions of substances in a membrane, according to some embodiments.

FIG. 4A illustrates X-ray diffraction (XRD) analysis of MXene powder (MX), sulfonated polyethersulfone and humic acid membrane (SH), a sulfonated polyethersulfone (SPES) membrane, and a formed membrane of the present disclosure (SHMx), according to some embodiments.

FIG. 4B illustrates X-ray photoelectron spectroscopy (XPS) survey spectra of MXene powder (MX), a sulfonated polyethersulfone and humic acid membrane (SH). a sulfonated polyethersulfone (SPES) membrane, and a formed membrane of the present disclosure (SHMx), according to some embodiments.

FIG. 4C illustrates high resolution scans for C Is for a sulfonated polyethersulfone (SPES) membrane, a sulfonated polyethersulfone and humic acid membrane (SH), and a formed membrane of the present disclosure (SHMx), according to some embodiments.

FIG. 4D illustrates high resolution scans for O 1s for a sulfonated polyethersulfone (SPES) membrane, a sulfonated polyethersulfone and humic acid membrane (SH), and a formed membrane of the present disclosure (SHMx), according to some embodiments.

FIG. 4E illustrates high resolution scans for S2p for a sulfonated polyethersulfone (SPES) membrane, a sulfonated polyethersulfone and humic acid membrane (SH), and a formed membrane of the present disclosure (SHMx), according to some embodiments.

FIG. 4F illustrates thermogravimetric analysis (TGA) for a sulfonated polyethersulfone membrane (SPES), a sulfonated polyethersulfone and humic acid membrane (SH), a sulfonated polyethersulfone and MXene membrane (MxS), and a formed membrane of the present disclosure (SHMx), according to some embodiments.

FIG. 5A illustrates a scanning electron microscope (SEM) cross-section of a formed membrane of the present disclosure (SHMx), according to some embodiments.

FIG. 5B illustrates a scanning electron microscope (SEM) cross-section of a formed membrane of the present disclosure (SHMx), according to some embodiments.

FIG. 5C illustrates a scanning electron microscope (SEM) cross-section of a sulfonated polyethersulfone (SPES) membrane, according to some embodiments.

FIG. 6 illustrates a schematic of a configuration cell, according to some embodiments.

FIG. 7A illustrates cation selectivity of a SHMx hybrid membrane and a PSK cation exchange membrane against ionic species with different hydrated diameters, according to some embodiments.

FIG. 7B illustrates the NaCl salinity gradient-dependent cation selectivity for a SHMx hybrid membrane and a PSK cation exchange membrane, according to some embodiments.

FIG. 7C illustrates the current density for a SHMx hybrid membrane and a PSK cation exchange membrane in the presence of foulants, according to some embodiments.

FIG. 7D illustrates resistivity across a SHMx hybrid membrane and a PSK cation exchange membrane in the presence of foulants, according to some embodiments.

FIG. 7E illustrates long-term stability (cation selectivity) of a SHMx hybrid membrane and a PSK cation exchange membrane under a salinity gradient of 50-fold, according to some embodiments.

FIG. 7F illustrates long-term stability (power density) of a SHMx hybrid membrane and a PSK cation exchange membrane under a salinity gradient of 50-fold, according to some embodiments.

FIG. 8A illustrates long-term stability (cation selectivity) of the SHMx hybrid membranes compared to a PSK membrane, according to some embodiments.

FIG. 8B illustrates long-term stability (cation selectivity) of the SHMx hybrid membranes compared to a PSK membrane, in the presence of Zn(NO₃)₂, according to some embodiments.

FIG. 8C illustrates long-term stability (cation selectivity) of the SHMx hybrid membranes compared to a PSK membrane, in the presence of Ni(NO₃)₂, according to some embodiments.

FIG. 8D illustrates long-term stability (cation selectivity) of the SHMx hybrid membranes compared to a PSK membrane, in the presence of phenol, according to some embodiments.

FIG. 8E illustrates long-term stability (power density) of the SHMx hybrid membranes compared to a PSK membrane, according to some embodiments.

FIG. 8F illustrates long-term stability (power density) of the SHMx hybrid membranes compared to a PSK membrane, in the presence of Zn(NO₃)₂, according to some embodiments,

FIG. 8G illustrates long-term stability (power density) of the SHMx hybrid membranes compared to a PSK membrane, in the presence of Ni(NO₃)₂, according to some embodiments.

FIG. 8H illustrates long-term stability (power density) of the SHMx hybrid membranes compared to a PSK membrane, in the presence of phenol, according to some embodiments.

FIG. 9A illustrates a comparative plot of membrane resistivity and energy conversion efficiency of SHMx, a PSK cation exchange membrane, and other membranes, according to some embodiments.

FIG. 9B illustrates unit cost of raw nanofiller materials per mass (g) or unit cost of membranes per 1 m² area, according to some embodiments.

### DETAILED DESCRIPTION

Embodiments of the present disclosure provide membranes, methods for forming such membranes, and systems capable of utilizing such membranes. Membranes of the present disclosure can be used as ion exchange membranes for various applications, such as electrodialysis, reverse electrodialysis, and metal removal/harvesting applications. For example, while ion exchange membranes can be used for energy conversion, conventional ion exchange membranes suffer from low selectivity or fouling due to challenging environments containing heavy metals or organic contaminants. Ion exchange membranes of the present disclosure exhibit excellent selectivity and fouling resistance, even in the presence of common heavy metals and foulants.

Membranes of the present disclosure include hybrid matrix membranes. Hybrid matrix membranes include material(s) (e.g., nanomaterial(s)) dispersed in a polymeric matrix. The hybrid matrix membrane can include polymeric material, humic acid, and MXene material. The polymeric material can include a plurality of polymers. For example, the polymeric material can include a plurality of sulfonated polymers. Sulfonated polymers can be formed by introducing (e.g., adding) one or more sulfonic acid groups (—SO₃H) to at least a portion of a polymer structure. Examples of sulfonated polymers include sulfonated polyetheretherketone, sulfonated poly vinyl alcohol, sulfonated polysulfone, sulfonated polyvinylidene fluoride, and sulfonated polyethersulfone (SPES). The polymeric material can include one or more polysulfones or modified variants thereof (e.g., sulfonated). Polysulfones are thermoplastics including the aryl-SO₂-aryl subunit. Examples of polysulfones include polysulfone (PSU), polyethersulfone (PES) and polyphenylene sulfone (PPSU).

In one example, the polymeric matrix includes sulfonated polyethersulfone (SPES). Sulfonated polyethersulfone is a modified variant of polyethersulfone (PES), a high-performance thermoplastic polymer. Sulfonated polyethersulfone is a polymer with sulfonic acid functional groups attached to its aromatic rings. Sulfonated polyethersulfone is created by introducing sulfonic acid groups (—SO3H) to the polyethersulfone structure through a process called sulfonation. Sulfonated polyethersulfone exhibits excellent performance for membrane applications of the present disclosure (e.g., electrodialysis, reverse electrodialysis, and metal removal/harvesting) and sulfonated polyethersulfone exhibits desirable compatibility with additional membrane components of the present disclosure (e.g., humic acid and/or MXene).

The sulfonation of polyethersulfone can be performed using sulfonating agents such as chlorosulfonic acid or concentrated sulfuric acid. For example, sulfuric acid may be contacted with dry polyethersulfone to form sulfonated polyethersulfone. The sulfonated polyethersulfone can have varying degrees of sulfonation. The degree of sulfonation can be controlled by the reaction time and the ratio of the sulfonating agent and polymer material. For example, the degree of sulfonation can be greater than 5%, greater than 10%, greater than 20%, or greater than 30%. In one example, the degree of sulfonation can be determined by nuclear magnetic resonance (NMR) spectroscopy. Sulfonation can increase the surface charge of the membrane, making it more negative. Sulfonation can also promote fouling resistance to the membrane, due to the presence of functional groups on the polymer backbone. Accordingly, sulfonated polyethersulfone exhibits excellent thermo-mechanical, oxidative, and chemical stability. Further, in one example, utilizing sulfonated polyethersulfone in the membrane instead of a perfluorosulfonic acid/polytetrafluoroethylene (PTFE) copolymer-based membrane or a fluorinated polymer membrane can reduce the overall cost of the membrane.

Humic acid (HA) includes phenol and carboxylic acid functional groups. The phenol and carboxylic acid functional groups can exhibit deprotonation properties, leading to the release of H⁺ ions. Humic acid includes hydrophilic regions (OH groups) and hydrophobic regions (aliphatic chains and aromatic rings). In one example, humic acids can include phenol, carboxylic acid, and one or more of enolic, quinone, and ether functional groups. Humic acids can also include sugars and peptides. Based on elemental analysis, humic acids can include about 35 to 60% C and about 15 to 30% O (atomic %). Humic acids can include H, N, and S. The H, N and S percentages based on elemental analysis can range from about 20 to 48%, about 0.4 to 4%, and about 0.05 to 1%, respectively (atomic %). Humic acids can have molecular weights ranging from 2.0 to 1300 kDa.

Humic acids can be partially soluble at neutral pH (e.g., pH value of about 7) and substantially soluble in alkaline conditions (pH value greater 7). This solubility can vary depending on the chemical composition and the origin of the humic acid. In alkaline media, phenolic and carboxylic groups are deprotonated, and the repulsion of these negatively charged groups causes the molecules to assume a stretched configuration. Humic acid can be formed from the decomposition of biomass, such as plant and animal matter. Additionally, humic acid can be extracted from peat or coal, or humic acid can be chemically synthesized using polymerization/condensation reactions. Compared with other materials like graphene oxide or carbon nanotubes, humic acid is more environmentally friendly and is much cheaper. By incorporating humic acid into the membrane, the membrane can exhibit enhanced selectivity and fouling resistance. Further, during the membrane formation process, humic acid exhibits excellent dispersion capacity with sulfonated polyethersulfone in the casting solution.

The membrane can include humic acid and a plurality of sulfonated polymers. Tuning the weight ratio of humic acid to the plurality of sulfonated polymers can improve the mechanical strength of the membrane and enhance selectivity. In one example, the weight ratio of humic acid to the plurality of sulfonated polymers ranges from about 15:100 to about 40:100. In another example, the weight ratio of humic acid to the plurality of sulfonated polymers ranges from about 20:100 to about 30:100. In another example, the weight ratio of humic acid to the plurality of sulfonated polymers ranges from about 23:100 to about 27:100. In another example, the weight ratio of humic acid to the plurality of sulfonated polymers is about 25:100.

The membrane can include humic acid and sulfonated polyethersulfone. Tuning the weight ratio of humic acid to sulfonated polyethersulfone can improve the mechanical strength of the membrane and enhance selectivity. In one example, the weight ratio of humic acid to sulfonated polyethersulfone ranges from about 15:100 to about 40:100. In another example, the weight ratio of humic acid to sulfonated polyethersulfone ranges from about 20:100 to about 30:100. In another example, the weight ratio of humic acid to sulfonated polyethersulfone ranges from about 23:100 to about 27:100. In another example, the weight ratio of humic acid to sulfonated polyethersulfone is about 25:100.

The weight ratio of humic acid to sulfonated polyethersulfone can be less than 28:100. In one non-limiting example, utilizing the weight ratio of humic acid to sulfonated polyethersulfone of less than 28:100 improves the overall mechanical strength of the membrane. The weight ratio of humic acid to sulfonated polyethersulfone can be greater than 22:100. In one non-limiting example, utilizing the weight ratio of humic acid to sulfonated polyethersulfone of greater than 22:100 improves membrane selectivity and promotes desirable intercalation.

The membrane can include one or more MXene materials. The MXene material(s) can be dispersed in the polymeric matrix. MXenes are a class of two-dimensional material including transition metal carbides, carbonitrides, and nitrides. The MXene can follow the formula: Mₙ₊₁Xₙ, where M is early transition metals (e.g., Ti, V, Cr, Y, Zr, Nb, Mo, Hf, Ta, or W); X is C or N; and n is 1, 2, or 3. If the MXene has surface terminations, the MXene can follow the formula: Mₙ₊₁XₙTₓ, where M is early transition metals (e.g., Ti, V, Cr, Y, Zr, Nb, Mo, Hf, Ta, or W); X is C or N; Tₓ refers to surface terminations such as OH, O, F, and/or Cl; and n is 1, 2, or 3. Tₓ can represent a variable number of these surface groups, which can vary depending on the synthesis method and conditions. In one example, the MXene includes OH and F surface terminations. The metal (M) may be selected based on the desired conductivity and selectivity of the membrane. The layered structure of the MXene can contribute to unique properties, such as combining beneficial characteristics of both ceramics and metals. For example, the MXene can feature high electrical conductivity and hydrophilic surfaces, and the MXene can feature adjustable surface properties and excellent mechanical strength. The MXene(s) may be present as exfoliated, two-dimensional nanosheets, and the MXene(s) can be homogenously distributed in the bulk of the membrane.

The MXene can exhibit multilayer nanoflakes having a stable hexagonal structure. In one example, the MXene includes Ti. In one non-limiting example, the MXene includes a titanium carbide MXene. For example, the MXene may follow the formula: Ti₃C₂Tₓ, where Tₓ is selected from OH, O, F, and/or Cl. In one example, the titanium carbide MXene is stable and provides desirable performance to the membrane for ion exchange applications. The Ti₃C₂Tₓ MXene nanosheets can be formed using in-situ HF etching. A MAX phase material, such as Ti₃AlC₂, can serve as the precursor. The etching process can involve a solution of hydrochloric acid and lithium fluoride to selectively remove the aluminum layer from the MAX phase. Subsequent purification steps include repeated washing and centrifugation to remove impurities. The washing process can continue until the pH value of the supernatant exceeds 6, indicating removal of impurities. Based on elemental analysis, the titanium carbide MXene can include 7-15 wt. % C, 10-15 wt. % O, 12-20 wt. % F, 0-5 wt. % Al (or 0.5-5 wt. % Al), and 45-65 wt. % Ti. Alternatively, or in addition to the Ti₃C₂Tₓ MXene, the MXene can include at least one of Ti₂CTₓ and V₂CTₓ.

The membrane can include a plurality of sulfonated polymers and one or more MXene materials. The weight ratio of the MXene material to the plurality of sulfonated polymers can be tuned to reduce internal resistance, decrease cost, and increase performance and selectivity. In one example, the weight ratio of the MXene material to the plurality of sulfonated polymers ranges from about 10:100 to about 30:100. In another example, the weight ratio of the MXene material to the plurality of sulfonated polymers ranges from about 15:100 to about 25:100. In another example, the weight ratio of the MXene material to the plurality of sulfonated polymers ranges from about 18:100 to about 22:100. In another example, the weight ratio of the MXene material to the plurality of sulfonated polymers is about 20:100.

The membrane can include sulfonated polyethersulfone and one or more MXene materials. The weight ratio of the MXene material to sulfonated polyethersulfone can be tuned to reduce internal resistance, decrease cost, and increase performance and selectivity. In one example, the weight ratio of the MXene material to sulfonated polyethersulfone ranges from about 10:100 to about 30:100. In another example, the weight ratio of the MXene material to sulfonated polyethersulfone ranges from about 15:100 to about 25:100. In another example, the weight ratio of the MXene material to sulfonated polyethersulfone ranges from about 18:100 to about 22:100. In another example, the weight ratio of the MXene material to sulfonated polyethersulfone is about 20:100.

The weight ratio of the MXene material to sulfonated polyethersulfone can be less than 23:100. In one non-limiting example, utilizing a weight ratio of the MXene material to sulfonated polyethersulfone of less than 23:100 decreases internal resistance and decreases cost. The weight ratio of the MXene material to sulfonated polyethersulfone can be greater than 17:100. In one non-limiting example, utilizing a weight ratio of the MXene material to sulfonated polyethersulfone of greater than 17:100 enhances membrane performance for ion exchange and can decrease internal resistance.

The membrane can include both humic acid and MXene material. In one example, the total weight of humic acid in the membrane is greater than the total weight of MXene material in the membrane. The weight ratio of MXene material to humic acid can range from 70:100 to 90:100. In one example, the weight ratio of MXene material to humic acid ranges from 75:100 to 85:100. In another example, the weight ratio of MXene material to humic acid ranges from 78:100 to 82:100. In another example, the weight ratio of MXene material to humic acid is about 80:100.

The polymeric material and humic acid can be at least partially intercalated between layers of the MXene material, Intercalation includes the inclusion or insertion of one or more distinct substances into layered structures. The polymeric material and humic acid can be at least partially intercalated between layers of the MXene material, sufficient to increase the interlayer spacing of the MXene material. For comparison and in one non-limiting example, for a membrane with MXene and sulfonated polyethersulfone, but without humic acid, the sulfonated polyethersulfone does not intercalate between MXene layers. The structural modification in membranes of the present disclosure facilitates hydrogen bonding and electrostatic interactions between the functional groups of the polymeric material and humic acid (sulfonic group, carboxylate, and hydroxyl) and O terminal groups of the MXene. Accordingly, the intercalation and increased interlayer spacing can provide a more open and accessible pathway for ion diffusion, reducing the internal resistance and improving the overall performance of the membrane.

In one example, the membrane includes a titanium carbide MXene, humic acid, and sulfonated polyethersulfone, where the titanium carbide MXene can interact with the humic acid via hydrogen bonding, and the sulfonated polyethersulfone can interact with the humic acid via hydrogen bonding. The combination of the titanium carbide MXene, humic acid, and sulfonated polyethersulfone can enhance the ion selectivity and transport properties of the membrane, enhancing energy conversion efficiency. Further, these membranes can exhibit high selectivity even in the presence of contaminants and foulants.

X-ray photoelectron spectroscopy (XPS) analysis can be used to determine the elemental composition of the membrane. These elements can be present from the polymeric material, humic acid, and MXene material. In one example, the atomic percentage of C in the membrane ranges from about 60% to about 80%. In another example, the atomic percentage of C in the membrane ranges from about 65% to about 72%. In one example, the atomic percentage of O in the membrane ranges from about 16% to about 30%. In another example, the atomic percentage of O in the membrane ranges from about 20% to about 25%. In one example, the atomic percentage of S in the membrane ranges from about 0.5% to about 3%. In another example, the atomic percentage of S in the membrane ranges from about 1.2% to about 2.5%, In one example, the atomic percentage of Ti in the membrane ranges from about 0.1% to about 2%. In another example, the atomic percentage of Ti in the membrane ranges from about 0.3% to about 1%.

The membrane can exhibit a tuned nanochannel height for the efficient transport of cations and retention of anions in ion exchange applications. The tuned nanochannel height can boost cation selectivity. In one example, the membranes exhibit a nanochannel height ranging from about 1 nm to about 5 nm. In another example, the membranes exhibit a nanochannel height ranging from about 1 nm to about 3 nm. In another example, the membranes exhibit a nanochannel height ranging from about 1 nm to about 2 nm. In another example, the membranes exhibit a nanochannel height of about 1.5 nm. The membrane can have a thickness of 10 μm to 1 cm. In one example, the membrane has a thickness ranging from 10 μm to 200 μm. The length and width of the membrane can be adjusted according to the desired application. For example, the membrane can have a length of greater than 1 cm, greater than 5 cm, greater than 50 cm, or greater than 100 cm. For example, the membrane can have a width of greater than 1 cm, greater than 5 cm, greater than 50 cm, or greater than 100 cm.

The presence of foulants, such as heavy metals and organic compounds, can significantly hinder the ion transport properties of conventional membranes. Examples of foulants include zinc ions and zinc containing-compounds, nickel ions and nickel-containing compounds, and phenol. These foulants can be common in water utilized in oil or gas production or industrial wastewater. Membranes of the present disclosure demonstrate high cation selectivity even in the presence of these contaminants. For comparison and in one non-limiting example, for a membrane with humic acid and sulfonated polyethersulfone, but without MXene, the comparison membrane has higher resistance. The confined structure of the MXene material and negative surface charge, in combination with humic acid, improves the selectivity and decreases the internal fluidic transport resistance of the membrane.

The membranes of the present disclosure can be utilized for various ion exchange applications. For example, the membranes of the present disclosure can be used as semi-permeable cation exchange membranes for various applications such as electrodialysis for water desalination. Cation exchange membranes are membranes that are selectively permeable to cations, while substantially blocking anions. In one example, the cation exchange membrane can selectively block over 90% of anions. In another example, the cation exchange membrane can selectively block over 95% of anions. Further, these membranes can be used as cation exchange membranes for reverse electrodialysis to generate energy. Membranes of the present disclosure can be used to remove/recover lithium from liquid streams. Additionally, these membranes can be used as a cation exchange membrane in a fuel cell.

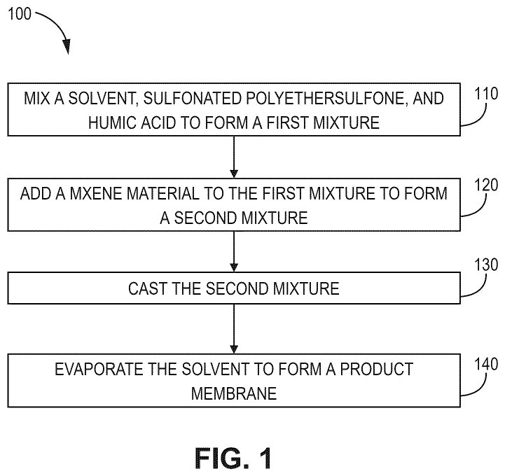

FIG. 1 illustrates a method for forming a membrane, according to some embodiments. Method 100 includes one or more of the following steps (with various orders possible):

Referring to Step 110, a solvent, sulfonated polyethersulfone, and humic acid are mixed to form a first mixture. Mixing can include contacting, stirring, heating, and/or placing in physical contact. The solvent, sulfonated polyethersulfone, and humic acid can be mixed simultaneously or in various orders. In one example, the solvent is mixed with the sulfonated polyethersulfone; then humic acid is added. In another example, the solvent is mixed with humic acid; then sulfonated polyethersulfone is added. In another example, the solvent is mixed with humic acid; additional solvent is mixed with sulfonated polyethersulfone, and the two mixtures are combined. The solvent, sulfonated polyethersulfone, and humic acid can be homogeneously mixed.

The solvent, sulfonated polyethersulfone, and humic acid can be mixed for a period of time sufficient for the first mixture to be in the form of a solution. In one example, the solvent, sulfonated polyethersulfone, and humic acid are mixed for more than 30 minutes, more than 1 hour, more than 4 hours, or more than 10 hours. The solvent, sulfonated polyethersulfone, and humic acid can be mixed at various temperatures, such as at about room temperature (e.g., about 20° C.). In one non-limiting example, method 100 can form membranes without utilizing water and/or a non-solvent.

The solvent includes one or more polar solvents. In one example, the polar solvent includes at least one of tetrahydrofuran (THF), N-methyl-2-pyrrolidone (NMP), Dimethylformamide (DMF), Dimethylacetamide (DMAc), and Dimethyl sulfoxide (DMSO). In one non-limiting example, the polar solvent includes N-methyl-2-pyrrolidone (NMP). NMP is a versatile solvent with high polarity, and NMP is miscible in water. NMP can be produced by an ester-to-amide conversion process. NMP also exhibits high chemical and thermal stability. The high polarity and excellent stability of NMP can ensure NMP is an effective solvent for methods of the present disclosure. The sulfonated polyethersulfone and humic acid include sulfonated polyethersulfone and humic acid as discussed herein.

Tuning the weight ratio of humic acid to sulfonated polyethersulfone can improve mechanical strength of the membrane and enhance selectivity. In one example, the weight ratio of humic acid to sulfonated polyethersulfone in the first mixture ranges from about 15:100 to about 40:100. In another example, the weight ratio of humic acid to sulfonated polyethersulfone in the first mixture ranges from about 20:100 to about 30:100. In another example, the weight ratio of humic acid to sulfonated polyethersulfone in the first mixture ranges from about 23:100 to about 27:100. In another example, the weight ratio of humic acid to sulfonated polyethersulfone in the first mixture is about 25:100. The weight ratio of humic acid to sulfonated polyethersulfone in the first mixture can be less than 28:100. In one non-limiting example, utilizing the weight ratio of humic acid to sulfonated polyethersulfone in the first mixture of less than 28:100 improves the overall mechanical strength of the membrane. The weight ratio of humic acid to sulfonated polyethersulfone in the first mixture can be greater than 22:100. In one non-limiting example, utilizing the weight ratio of humic acid to sulfonated polyethersulfone in the first mixture of greater than 22:100 improves membrane selectivity and promotes desirable intercalation.

Referring to Step 120, MXene material is added to the first mixture to form a second mixture. Adding the MXene material to the first mixture can include mixing the MXene material with the first mixture. Mixing can include contacting, stirring, heating, and/or placing in physical contact. The MXene material includes one or more MXene materials of the present disclosure. The first mixture and MXene material can be mixed for a period of time sufficient for the second mixture to be in the form of a solution. In one example, the first mixture and MXene material are mixed for more than 30 minutes, more than 1 hour, more than 4 hours, or more than 10 hours. The first mixture and MXene material can be mixed at various temperatures, such as at about room temperature (e.g., about 20° C.).

The MXene material can be added in the form of MXene powder. In one example, the MXene powder has a mean particle size in a range of between 0.1 and 100 μm. In another example, the MXene powder has a mean particle size in a range of between 0.1 and 60 μm. In another example, the MXene powder has a mean particle size in a range of between 0.1 and 40 μm. In another example, the MXene powder has a mean particle size of less than about 60 μm. In another example, the MXene powder has a mean particle size of less than about 40 μm. For the purposes hereof, the term “mean particle size” refers to a cumulative weight average value (d₅₀) in which 50% of the particles are larger than the value, and 50% of the particles are smaller than the value. Particle size can be determined by laser light diffraction. The shape of the MXene powder particles can be in an aspherical shape, such as flake-like or plate-like.

By performing Step 110 before Step 120, the humic acid and sulfonated polyethersulfone can be mixed prior to adding the MXene material. Mixing the humic acid and sulfonated polyethersulfone first can promote homogeneous mixing of the humic acid and sulfonated polyethersulfone. This promotes interactions between the humic acid and sulfonated polyethersulfone, such as hydrogen bonding. In one non-limiting example, membranes formed by performing Step 110 before Step 120 exhibit better ion selectivity performance and mechanical properties compared to a membrane formed by simultaneously mixing humic acid, sulfonated polyethersulfone, and the MXene material.

Referring to Step 130, the second mixture is cast. The second mixture can be cast on a plate (e.g., glass plate). Casting can include using a casting knife. In one example, the second mixture is cast to a thickness of 50 μm to 500 μm. In another example, the second mixture is cast to a thickness of 50 μm to 200 μm. In another example, the second mixture is cast to a thickness of 75 μm to 150 μm. While Step 130 may not always be required, it can be desirable to use casting to obtain desirable membrane thicknesses for ion exchange membranes.

Referring to Step 140, the solvent is evaporated to form a product membrane. The solvent is generally at least partially evaporated. The solvent can be evaporated at elevated temperatures using a vacuum system. Alternatively, the solvent can be evaporated under nitrogen atmosphere. In one example, the solvent is evaporated at a temperature of greater than 40° C. In another example, the solvent is evaporated at a temperature of greater than 50° C. In another example, the solvent is evaporated at a temperature of greater than 60° C. Step 140 can be performed simultaneously with, or after, Step 130.

Method 100 can efficiently form membranes of the present disclosure for various ion exchange applications. In one non-limiting example, compared to phase inversion using water and an exchange between a solvent and non-solvent, method 100 forms a membrane with enhanced selectivity. The incorporation of the MXene material can significantly enhance the cation selectivity and energy conversion efficiency. Further, the nanoconfined structure and surface properties of the MXene material can contribute to the selective pumping of cations and retention of anions, further boosting cation selectivity.

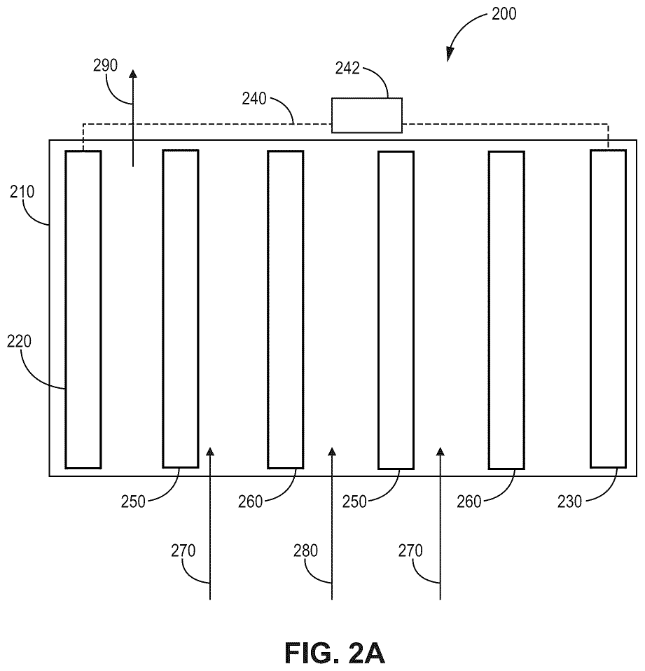

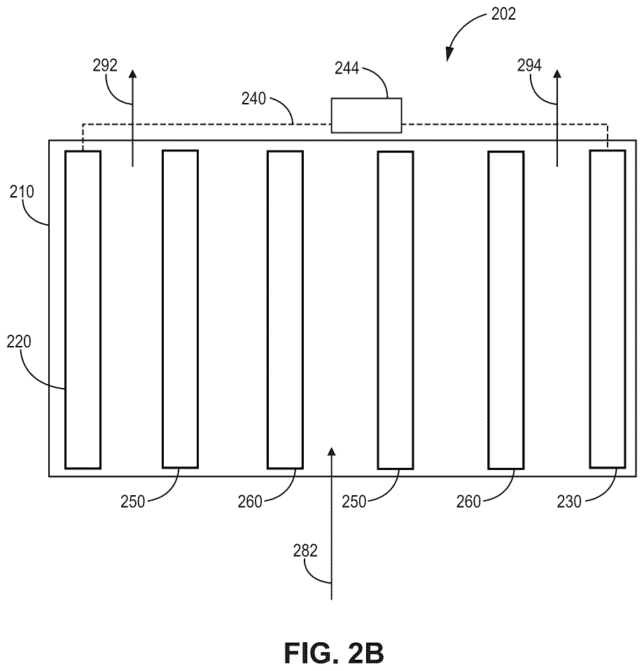

FIG. 2A illustrates a reverse electrodialysis system, according to some embodiments. Reverse electrodialysis system 200 is capable of generating electricity from salinity gradients. Reverse electrodialysis system 200 includes vessel 210, anode 220, cathode 230, electrical connection 240, electrical apparatus 242, anion exchange membrane 250, cation exchange membrane 260, first feed stream 270, second feed stream 280, and exit stream 290. Reverse electrodialysis system 200 utilizes one or more anion exchange membranes and one or more cation exchange membranes between electrodes to generate electricity from salinity gradients.

Vessel 210 includes a structure for permitting the flow of liquid across anion exchange membrane 250 and cation exchange membrane 260. For example, vessel 210 can be used to contain liquid(s) used within reverse electrodialysis system 200, such as liquid(s) provided by first feed stream 270 and second feed stream 280. Anode 220, cathode 230, anion exchange membrane 250, and cation exchange membrane 260 can be positioned within vessel 210. Vessel 210 can include one more inlets and one or more outlets for fluid flow. Vessel 210 can be in fluid communication with one or more liquid pumps for transferring liquid(s) into or out of vessel 210.

Anode 220 facilitates an oxidation reaction, where oxygen gas can be produced. The oxidation reaction at anode 220 can drive movement of ions through the membranes, creating an electrical current. Anode 220 generally includes one or more electrodes. Examples of anode materials include titanium-containing anodes and graphite containing anodes. Examples of titanium-containing anodes include titanium coated with one or more mixed metal oxides, platinized titanium, and titanium coated with ruthenium. In another example, anode 220 includes a silver-based electrode, such as Ag/AgCl.

Cathode 230 facilitates a reduction reaction, where hydrogen gas can be produced. The reduction reaction can allow for the completion of the electrical circuit, providing a pathway for electrons to flow from anode 220 to cathode 230. Cathode 230 generally includes one or more electrodes. Examples of cathode materials include stainless steel, carbon-based cathodes, and titanium-containing cathodes. One examples of a carbon-based cathode is graphite. One example of a titanium-containing cathode includes titanium coated with one or more mixed metal oxides. In another example, cathode 230 includes a silver-based electrode, such as Ag/AgCl. Cathode 230 can be in electrical communication with anode 220.

Anion exchange membrane 250 allows the selective transport of anions, while substantially rejecting cations. Anion exchange membrane 250 can include positively charged groups bound to a polymeric backbone, such as in the presence of water. Anion exchange functional groups can be either strongly basic, such as tertiary ammonium, or weakly basic, such as primary, secondary or tertiary amine groups. Examples of polymeric materials used in anion exchange membrane 250 include polysulfone, polyether ether ketone, and polyether sulfone ketone. While two anion exchange membrane 250 are shown in FIG. 2A, reverse electrodialysis system 200 can include one anion exchange membrane 250, or more than two anion exchange membrane 250.

Cation exchange membrane 260 allows the selective transport of cations, while substantially rejecting anions. Cation exchange membrane 260 includes a membrane of the present disclosure. Compared to membranes made of a copolymer of poly(tetrafluoroethylene) and polysulfonyl fluoride vinyl ether, cation exchange membrane 260 is highly efficient for reverse electrodialysis and is lower cost. Further, since cation exchange membrane 260 can include MXene material, the negatively charged hydroxyl groups on the MXene surface of cation exchange membrane 260 can facilitate interactions with sodium ions, creating additional cation transport channels. While two cation exchange membrane 260 are shown in FIG. 2A, reverse electrodialysis system 200 can include one cation exchange membrane 260, or more than two cation exchange membrane 260. Anion exchange membrane 250 and cation exchange membrane 260 are generally positioned in an alternating orientation within vessel 210. Anion exchange membrane 250 and cation exchange membrane 260 are generally separated by liquid(s).

First feed stream 270 includes a liquid having a greater concentration of salt in the liquid compared to second feed stream 280. Therefore, first feed stream 270 includes a liquid having a greater salinity compared to second feed stream 280. The liquid can include water. The salt can be present as one or more salt ions. Examples of salt ions include sodium, chloride, magnesium, sulfate and calcium. In one example, first feed stream 270 includes seawater. First feed stream 270 can include a liquid having a salt concentration of greater than 5 g/L. In one example, first feed stream 270 includes a liquid having a salt concentration of greater than 15 g/L. In another example, first feed stream 270 includes a liquid having a salt concentration of greater than 30 g/L. First feed stream 270 can exhibit a salinity of greater than 4 times the salinity of second feed stream 280. First feed stream 270 can exhibit a salinity of greater than 10 times the salinity of second feed stream 280. First feed stream 270 can exhibit a salinity of greater than 40 times the salinity of second feed stream 280.

Second feed stream 280 includes a liquid having a lower concentration of salt in the liquid compared to first feed stream 270. Therefore, second feed stream 280 includes a liquid (e.g., water) having a lower salinity compared to first feed stream 270. Therefore, reverse electrodialysis system 200 can harness energy from the Gibbs free energy of mixing under a salinity gradient. The liquid in second feed stream 280 can include water. Second feed stream 280 can include a liquid having a salt concentration of less than 3 g/L. In one example, second feed stream 280 includes a liquid having a salt concentration of less than 1 g/L.

First feed stream 270 and second feed stream 280 can each be introduced into vessel 210 at various positions. First feed stream 270 and second feed stream 280 are generally introduced into vessel 210 sufficient for liquid to be introduced adjacent to at least one of anion exchange membrane 250 and cation exchange membrane 260. First feed stream 270 and second feed stream 280 can each be introduced into vessel 210 using one or more liquid pumps. While first feed stream 270 and second feed stream 280 are illustrated in FIG. 2A as being introduced in a parallel flow orientation, first feed stream 270 and second feed stream 280 can alternatively be introduced in a counter-current flow orientation. After introduction of first feed stream 270 and second feed stream 280 adjacent to at least one of anion exchange membrane 250 and cation exchange membrane 260, cations and anions can substantially flow in opposite directions.

The presence of anion exchange membrane 250 and cation exchange membrane 260 allows the production of renewable energy by converting the salinity gradient into an ionic current and, in a second step, into electricity using the electrodes (anode 220 and cathode 230). Anode 220 and cathode 230 can be in electrical communication via electrical connection 240. Electrical connection 240 allows a circuit to be formed from anode 220 to cathode 230 using an external circuit. Electrical apparatus 242 can be used as an electrical load, where the electrons can be used to power the electrical load. During production of electricity, one or more fluid streams can be formed and can exit vessel 210. Exit stream 290 includes liquid(s) and can exit vessel 210 via one or more outlets. The liquid can include water. While one exit stream 290 is illustrated in FIG. 2A, reverse electrodialysis system 200 can include more than one exit stream 290.

The performance of ion exchange membranes in reverse electrodialysis applications can be influenced by one or more of electrical resistance, permselectivity, and biofouling propensity. Enhancing these characteristics can improve the cost-effectiveness and energy efficiency of the reverse electrodialysis process. Membranes of the present disclosure exhibit enhanced ion selectivity and energy conversion efficiency compared to conventional ion exchange membranes. Further, these membranes exhibit improved fouling resistance. Therefore, the membranes can be used for longer periods of time without replacement.

FIG. 2B illustrates an electrodialysis system, according to some embodiments. Electrodialysis system 202 is capable of at least partially desalinating saline water using electricity. Electrodialysis system 202 can utilize electricity and ion exchange membranes to separate salts from water. Accordingly, electrodialysis system 202 can produce desalinated water and a concentrated brine. Electrodialysis system 202 includes vessel 210, anode 220, cathode 230, electrical connection 240, electrical apparatus 244, anion exchange membrane 250, cation exchange membrane 260, saline feed stream 282, concentrate stream 292, and product stream 294.

Each of the vessel 210, anode 220, cathode 230, anion exchange membrane 250, and cation exchange membrane 260 in electrodialysis system 202 can include one or more features, configurations, materials, and/or orientations as discussed for the components used in reverse electrodialysis system 200. Anode 220 can include one or more carbon-based materials or titanium-containing materials. Cathode 230 can include one or more carbon-based materials or titanium-containing materials. In one example, cation exchange membrane 260 includes sulfonated polyethersulfone, humic acid, and MXene material.

Saline feed stream 282 can be introduced into vessel 210 between anion exchange membrane 250 and cation exchange membrane 260. While one saline feed stream 282 is shown in FIG. 2B, more than one saline feed stream 282 can be utilized. Saline feed stream 282 can include saline liquid(s) (e.g., seawater). The liquid can include water. The salt can be present as one or more salt ions. Examples of salt ions include sodium, chloride, magnesium, sulfate and calcium. Saline feed stream 282 can include a liquid having a salt concentration of greater than 5 g/L. In one example, saline feed stream 282 includes a liquid having a salt concentration of greater than 15 g/L. In another example, saline feed stream 282 includes a liquid having a salt concentration of greater than 30 g/L. Saline feed stream 282 can be provided to electrodialysis system 202 using one or more liquid pumps.

Electrical apparatus 244 is electrically connected to anode 220 and cathode 230. In one example, electrical apparatus 244 includes a power supply. Voltage is applied between anode 220 and cathode 230, and electrons flow from cathode 230 to anode 220. An electrical potential difference is utilized in combination with anion exchange membrane 250 and cation exchange membrane 260 to separate ionic species. Accordingly, as saline feed stream 282 is introduced within electrodialysis system 202, negative and positive ions originally in saline feed stream 282 can be separated from water to form concentrate stream 292 and product stream 294. Product stream 294 includes the desirable desalinated (e.g., at least partially desalinated) water. Product stream 294 has a lower salinity than both saline feed stream 282 and concentrate stream 292. Concentrate stream 292 and product stream 294 can each be transferred out of electrodialysis system 202 using one or more liquid pumps.

Concentrate stream 292 generally includes liquid having a greater salinity compared to saline feed stream 282. Concentrate stream 292 can include a liquid having a salt concentration of greater than 5 g/L. In one example, concentrate stream 292 includes a liquid having a salt concentration of greater than 15 g/L. In another example, concentrate stream 292 includes a liquid having a salt concentration of greater than 30 g/L. Product stream 294 includes one or more liquids. The liquid in product stream 294 can include water. Product stream 294 can include a liquid having a salt concentration of less than 3 g/L. In one example, product stream 294 includes a liquid having a salt concentration of less than 1 g/L. In another example, product stream 294 includes a liquid having a salt concentration of less than 500 mg/L.

Membranes of the present disclosure can be used to selectively recover monovalent cations from a liquid. For example, the membrane can be utilized to separate lithium (e.g., Li⁺ ions) from complex brines, such as brines including sodium, magnesium, zinc, calcium, and/or potassium. In one non-limiting example, the membrane exhibits a preference for monovalent cations compared to divalent cations, exhibiting size-dependent steric sieving and electrostatic repulsion. Therefore, the membrane can at least partially separate lithium from a liquid feed stream including lithium and one or more of magnesium (e.g., Mg²⁺ ions) and zinc (e.g., Zn²⁺ ions). The liquid feed stream can include water. Enhanced hydrophobic properties of the membrane can cause higher rejection (lower selectivity) for divalent ions, enhancing the separation of monovalent ions, such as lithium ions.

Importantly, membranes of the present disclosure exhibit enhanced ion selectivity in ion exchange applications. These membranes can be used as cation exchange membranes for electrodialysis to desalinate water and for reverse electrodialysis to generate energy. Further, membranes of the present disclosure can be used to remove/recover lithium from liquid streams. These membranes also exhibit improved fouling resistance-making these membranes desirable for applications that utilize liquids having one or more common foulants, Due to the improved fouling resistance, the membrane can exhibit enhanced selectivity and low resistance for longer periods of time, reducing the operating costs in ion exchange applications.

### Example 1—Membrane Preparation

Ti₃C₂Tₓ MXene nanosheets were fabricated using in-situ HF etching. A ternary carbide MAX phase material, Ti₃AlC₂ (particle size <40 μm), served as the precursor. The etching process included utilizing a solution of hydrochloric acid (HCl 35-38%) and lithium fluoride (LiF) to selectively remove the aluminum layer from the MAX phase. Subsequent purification steps included repeated washing and centrifugation to remove impurities. The washing process continued until the pH of the supernatant exceeded 6, indicating removal of impurities. The final product was a stable, dark green supernatant including the desired Ti₃C₂Tₓ MXene nanosheets.

The SHMx hybrid membrane was prepared using solvent evaporation. First, polymer concentration of 10% sulfonated polyethersulfone (SPES) was blended with 2.5 wt. % humic acid (HA) for one day. Then, 2 wt. % of MXene powder was incorporated into the polymer solution and stirred for 24 hours. The polymer solution was cast to a thickness of 100 μm on a clean glass plate and placed in a vacuum oven at 70° C. for 24 hours. The resulting nanocomposite membranes are denoted as SHMx, with S, H, and Mx representing HA, SPES, and MXene.

### Example 2—Membrane Component Interactions During and After Preparation

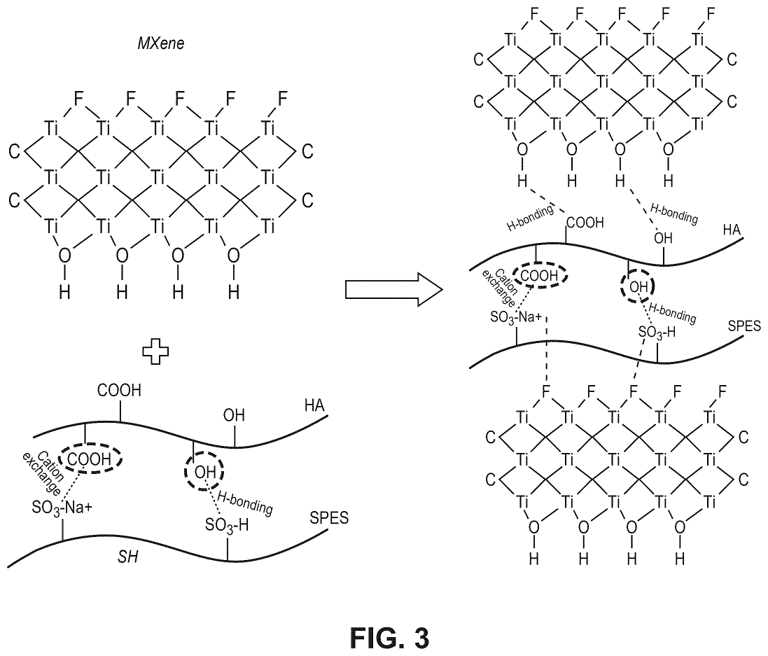

FIG. 3 illustrates interactions of substances in a membrane, according to some embodiments. As shown, humic acid and sulfonated polyethersulfone can be mixed together to form “SH”, where hydrogen bonding interactions occur between at least a portion of the humic acid and at least a portion of the sulfonated polyethersulfone. For example, hydrogen bonding interactions can form between a hydroxyl group of humic acid and sulfonic group of sulfonated polyethersulfone. When MXene material is mixed with “SH”, due to the hydroxyl and carboxylic groups of humic acid, hydrogen bonding interactions occur between the MXene material and at least a portion of “SH”. The abundant functional groups within HA acid facilitate enhanced interactions with MXene, leading to increased interlayer spacing and stronger hydrogen bonding and electrostatic interactions between the functional groups of SH and MXene. The formed membrane is named SHMx.

### Example 3—Membrane Characterization

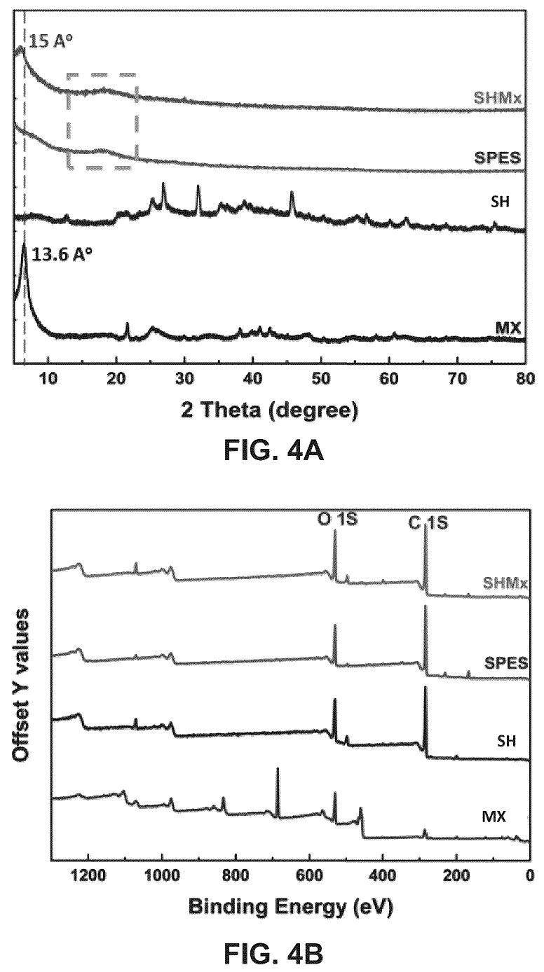

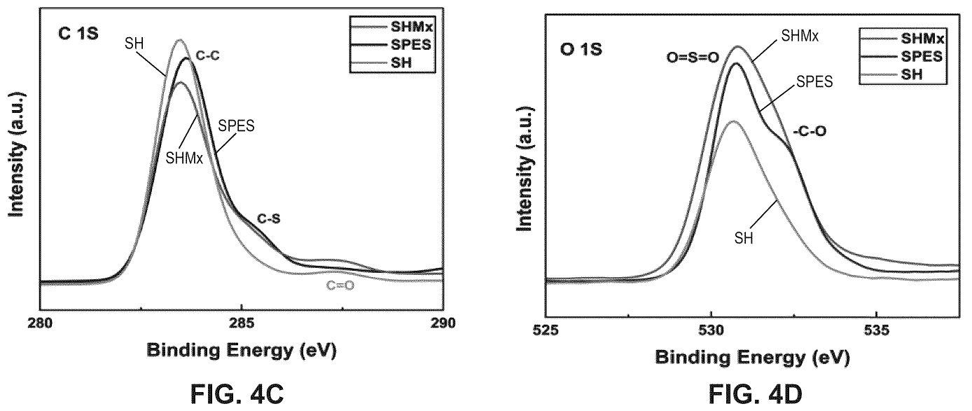

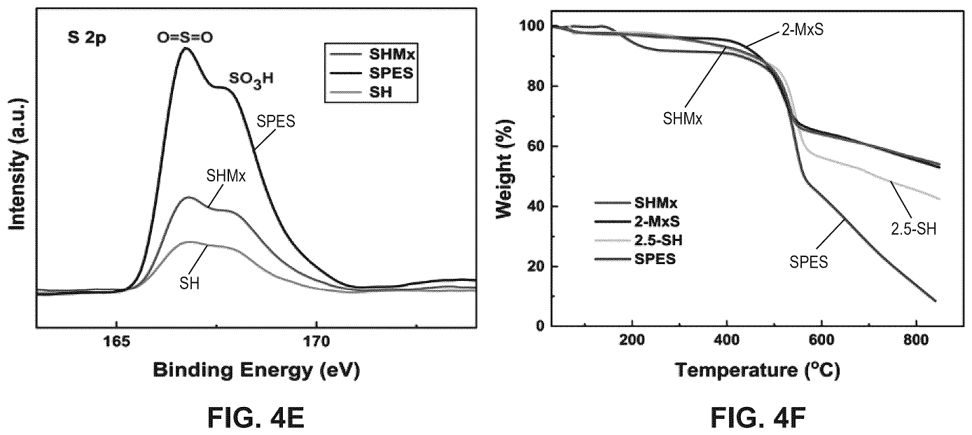

FIG. 4A illustrates X-ray diffraction (XRD) analysis of MXene powder (MX), sulfonated polyethersulfone and humic acid membrane (SH), a sulfonated polyethersulfone (SPES) membrane, and a formed membrane of the present disclosure (SHMx), according to some embodiments. XRD analysis of the SHMx membrane revealed a significant shift in the spectral peaks compared to the SH and MxS membranes. The incorporation of MXene and HA resulted in the emergence of two distinct peaks: one at 5.9° attributed to the MXene structure, and another at 30° associated with the HA component. In the case of MxS nanocomposite membrane, the polymer did not intercalate between the MXene layers. However, the addition of SH polymer led to a noticeable broadening and shifting of the crystalline peak from 6.5° to a lower angle of 5.9°. This indicates an increase in the interlayer spacing of the MXene from 1.36 to 1.5 nanometers, showing that the SH had successfully partially intercalated between MXene layers. This structural modification facilitates hydrogen bonding and electrostatic interactions between the functional groups of SH (sulfonic group, carboxylate, and hydroxyl) and O terminal groups of the MXene, leading to improved ion transport and reduced membrane resistivity.

FIG. 4B illustrates X-ray photoelectron spectroscopy (XPS) survey spectra of MXene powder (MX), a sulfonated polyethersulfone and humic acid membrane (SH), a sulfonated polyethersulfone (SPES) membrane, and a formed membrane of the present disclosure (SHMx), according to some embodiments. XPS analysis revealed significant changes in the SPES membrane structure after incorporating HA and MXene.

FIG. 4C illustrates high resolution scans for C Is for a sulfonated polyethersulfone (SPES) membrane, a sulfonated polyethersulfone and humic acid membrane (SH), and a formed membrane of the present disclosure (SHMx), according to some embodiments. The C Is spectrum showed peaks corresponding to the C—C bonds of SPES and C═O bonds of HA, similar to the SH membrane. However, the addition of MXene led to a slight shift in the C═O and C—S peaks towards higher binding energies and a decrease in their intensities.

FIG. 4D illustrates high resolution scans for O Is for a sulfonated polyethersulfone (SPES) membrane, a sulfonated polyethersulfone and humic acid membrane (SH), and a formed membrane of the present disclosure (SHMx), according to some embodiments. The O 1s spectrum of the SHMx membrane exhibited a single peak attributed to O═S═O and C═O, similar to SH but with higher intensity due to the presence of MXene.

FIG. 4E illustrates high resolution scans for S2p for a sulfonated polyethersulfone (SPES) membrane, a sulfonated polyethersulfone and humic acid membrane (SH), and a formed membrane of the present disclosure (SHMx), according to some embodiments, Changes occurred in the S 2p spectrum, where SHMx showed a broadened peak with increased intensity of SO₂ bonds, showing enhanced interactions between the functional groups of SH and the terminal oxygen groups of MXene layers.

Elemental analysis of the SHMx hybrid membrane revealed significant compositional changes compared to the unmodified SPES and SH membranes (Table 1). The atomic percentage of carbon atoms decreased notably in SHMx (69.6%), while the oxygen content increased substantially (23.16%), showing the successful incorporation of MXene. Additionally, a slight increase in sulfur content was observed. These compositional shifts highlight the positive impact of HA and MXene on the membrane structure and properties. The abundant functional groups within HA acid facilitated enhanced interactions with MXene, leading to increased interlayer spacing and stronger hydrogen bonding and electrostatic interactions between the functional groups of SH (sulfonic group, hydroxyl, and carboxylic) and MXene (F/OH). Consequently, the increased interlayer spacing can provide a more open and accessible pathway for ion diffusion, reducing the internal resistance and improving the membrane's overall performance.

TABLE 1
The elemental composition of MXene powder, HA powder,
SPES, SH membrane, and SHMx membrane by XPS technique.

| MXene | | | HA | | SPES | | SH | | SHMx | |
|---|---|---|---|---|---|---|---|---|---|---|
| | Peak | Atomic | Peak | Atomic | Peak | Atomic | Peak | Atomic | Peak | Atomic |
| | BE | % | BE | % | BE | % | BE | % | BE | % |
| C1s | 285.71 | 24.6 | 284.01 | 73.43 | 283.78 | 74.65 | 283.7 | 78.54 | 283.82 | 69.59 |
| O1s | 531.01 | 25.44 | 531.45 | 22.65 | 531.02 | 17.23 | 530.87 | 15.31 | 531.02 | 23.16 |
| S2p | | | | | 167.24 | 4.8 | 167.33 | 1.07 | 167.4 | 1.8 |
| Ti2p | 458.91 | 15.45 | | | | | | | 456.95 | 0.52 |

FIG. 4F illustrates thermogravimetric analysis (TGA) for a sulfonated polyethersulfone membrane (SPES), a sulfonated polyethersulfone and humic acid membrane (SH), a MXene and sulfonated polyethersulfone membrane (MxS), and a formed membrane of the present disclosure (SHMx), according to some embodiments. TGA analysis revealed that the incorporation of MXene nanosheets into the SPES matrix slightly decreased the thermal stability of the resulting SHMx composite membrane. While the pure SPES and SH membranes exhibited thermal degradation temperatures of 565° C. and 572.5° C., respectively, the SHMx composite started to decompose at a lower temperature of 551° C. Despite this decrease in initial thermal stability, the SHMx membrane demonstrated significantly higher residual weight percentages (54%) compared to the pure SPES (8.5%) and SH (42.5%) membranes. This shows that the presence of MXene nanosheets when homogeneously distributed within the SH matrix and interacting through hydrogen bonding and electrostatic forces, can enhance the overall thermal stability of the composite material. Proton NMR spectroscopy revealed that the structural integrity of the SPES polymer backbone remained mostly unaffected after the introduction of HA and MXene nanosheets. In one example, notable interactions between these components occurred through the functional groups of SH (mainly HA) and the oxygen-containing groups of MXene, without significantly disrupting the overall structure of the SPES polymer.

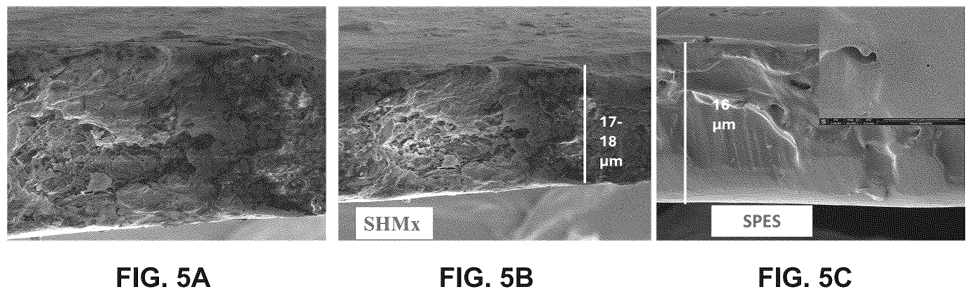

FIG. 5A illustrates a scanning electron microscope (SEM) cross-section of a formed membrane of the present disclosure (SHMx), according to some embodiments. FIG. 5B illustrates a scanning electron microscope (SEM) cross-section of a formed membrane of the present disclosure (SHMx), according to some embodiments. FIG. 5C illustrates a scanning electron microscope (SEM) cross-section of a sulfonated polyethersulfone (SPES) membrane, according to some embodiments. The incorporation of SH polymer into MXene nanosheets resulted in a significant modification of the morphological characteristics, as shown by cross-sectional analysis. The morphology of these hybrid membranes showed a more open and porous structure, indicative of a uniform dispersion of MXene nanosheets within the SH polymer matrix resulting in a notable effect on the membrane thickness. SHMx membranes exhibited slightly increase in thickness to 18 μm. The observed changes in morphology and thickness can have an effect on the performance of the membranes. The increased porosity can enhance the transport of molecules through the membrane, while the increased thickness can improve the mechanical strength and barrier properties.

### Example 4—Configuration Cell

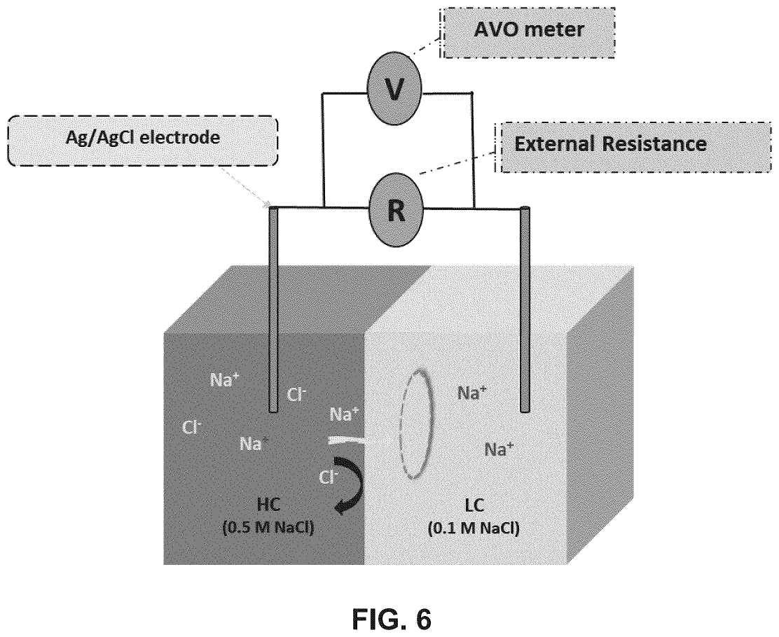

FIG. 6 illustrates a schematic of a configuration cell, according to some embodiments. Power generation measurements were conducted using a multimeter, a pair of Ag/AgCl electrodes, and an external load. As depicted, the nanocomposite membrane was positioned within a two-compartment conductivity cell, with an effective membrane area of approximately 0.785 cm². The two chambers were filled with 0.5/0.1 M NaCl. In subsequent energy conversion experiments, the surface (active layer) of the CEM faced the HCS side. Open circuit potential (V_{oc}) was determined by measuring the voltage drop across the membrane in the two-cell configuration. The membrane potential (osmotic potential) was adjusted by deducting the redox potential caused by the salinity gradient present on the surface of Ag/AgCl electrodes, utilizing the Nerst equation below (Equation 1):

$$Δ {V}_{redox} = \frac{RT}{zF} ln ( \frac{{a}_{c}}{{a}_{d}} ) \qquad ( 1 )$$

where ΔV_{redox} is the redox potential generated between the two electrodes surface (V), R is the gas constant (8.314 J·(mol·K)−1), T′ is the absolute temperature (K), z is the electrochemical valence, F is the Faraday constant (96,485 C·mol-1), a, is the activity of the concentrated solution (mol·L-1) and a_{d} is the activity of the diluted solution (mol·L-1).

For the dilute compartment (0.1 M NaCl, η=0.778) and concentrated compartment (0.5M NaCl, η=0.681), the activity is the product of the activity coefficient n and the concentration. The theoretical voltage difference per membrane is 37.9 mV. The voltage drops (Vₑₓₜ) and current produced (Iₑₓₜ) under various external resistances were also analyzed to identify the maximum current density (Iₑₓₜ=Vₑₓₜ/Rₑₓₜ·Aₘ) and power density per membrane area

$$( P = {I}_{ext}^{2} \cdot {R}_{ext} / {A}_{m} ) .$$

The internal resistance (Rᵢₙ) was also calculated based on Rᵢₙ(Ω)=(V_{oc}−Vₑₓₜ)/Iₑₓₜ. Then, the resistivity (μΩ·m) was calculated according to Equation 2:

$$ρ ( Ω . m ) = \frac{R \times S}{t} \qquad ( 2 )$$

where t is the membrane thickness (m), S is the surface area of the tested membrane between the two electrodes (m²), and R is its electrical resistance (Ω).

The ion transport measurements were conducted using a membrane with an active area of 50.24 mm². A source meter and Ag/AgCl electrodes were used to evaluate the current-voltage (IV) characteristics across membranes. The electrode distance was maintained at 20 mm. Moreover, to assess operational stability and energy harvesting potentials for 48 hours, two streams of synthesized oilfield-PW with 50-fold salinity gradients of 0.5 to 0.01 mol/L filled the HCS and LCS compartments, respectively. Fouling analysis was performed by introducing 20 mg L⁻¹ (or ppm) of zinc, nickel, or phenol into the HCS compartment while maintaining the same salinity gradient.

### Example 5—Osmotic Power Generation

As shown in Table 2, the incorporation of MXene into the SH polymer matrix significantly enhanced the cation selectivity and energy conversion efficiency. SHMx exhibited cation transference numbers of 0.98, attributed to the nanoconfined channels of approximately 1.5 nm that facilitated ion transport and selectivity. MXene's unique nanoconfined structure and surface properties also contributed to the selective pumping of cations and retention of anions, further boosting cation selectivity. The nanochannel height of 1.5 nm can allow for the overlapping of electrical double layers, enhancing cation selectivity and energy conversion efficiency. SHMx achieved energy conversion efficiencies of 45.6% under 5-fold concentration gradients. Additionally, the developed membranes demonstrated lower internal fluidic transport resistances compared to the unmodified SH and MxS membranes.

SHMx exhibited resistances of 0.004 μΩ·m, while SH and MxS had resistances of 0.00445 μΩ·m and 0.018 μΩ·m, respectively. These lower resistances resulted in higher ionic current and power density, reaching 18.6 mW·m⁻². The incorporation of MXene into SH polymer matrix offers significant advantages in terms of cation selectivity and energy conversion efficiency.

TABLE 2
Salinity gradient energy harvesting across the SHMx membranes.

| | Cation | Membrane | Pd max | Energy |
|---|---|---|---|---|
| Type of | transference | resistivity | (mW · | conversion |
| Membrane | number (t⁺) | (micro Ohm · m) | m⁻²) | efficiency (%) |
| SHMx | 0.97556 | 0.004 | 18.29 | 45.23 |

### Example 6—Ion Transport Characteristics and Impact of Fouling

The cation selectivity of SHMx hybrid membranes was further assessed using IV characteristics and derived ionic current densities under various conditions. The IV characteristics and derived ionic current densities of hybrid membranes were assessed by exploring osmotic ion flow with varying ionic valences and spanning a wide range of effective hydrated ionic volumes. The salinity gradient ion transport was investigated in the presence of foulants, such as Ni(NO₃)₂, Zn(NO₃)₂, or phenol.

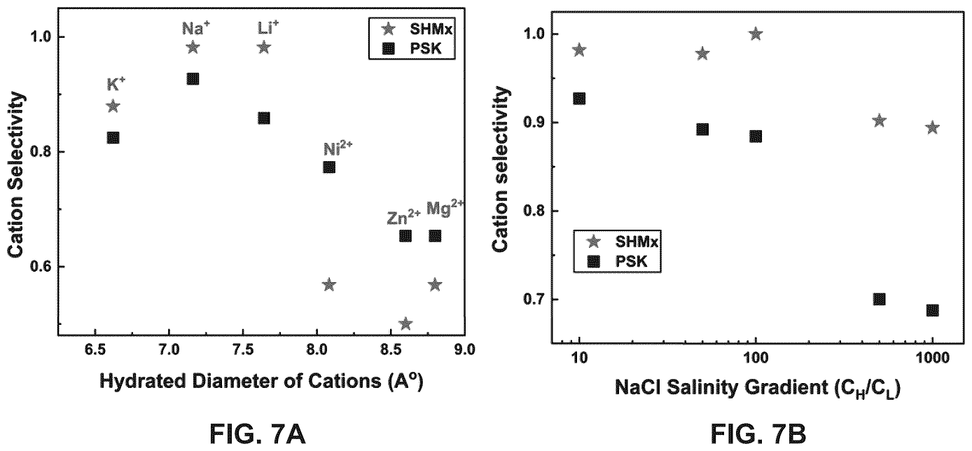

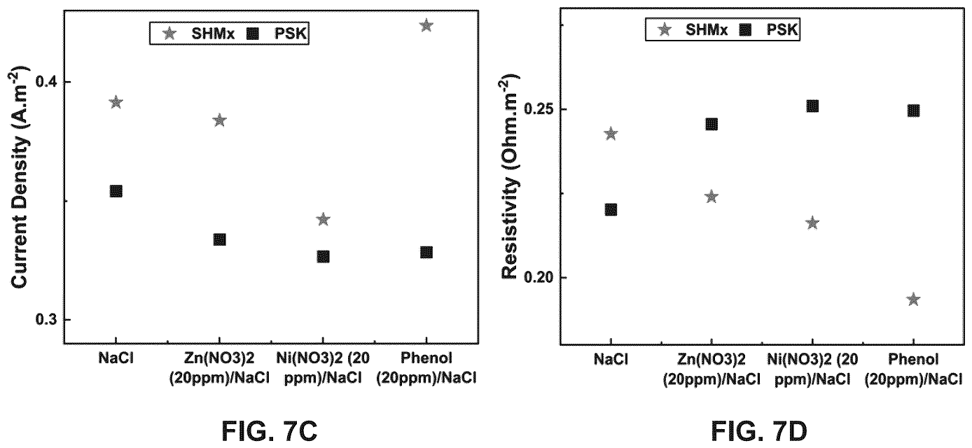

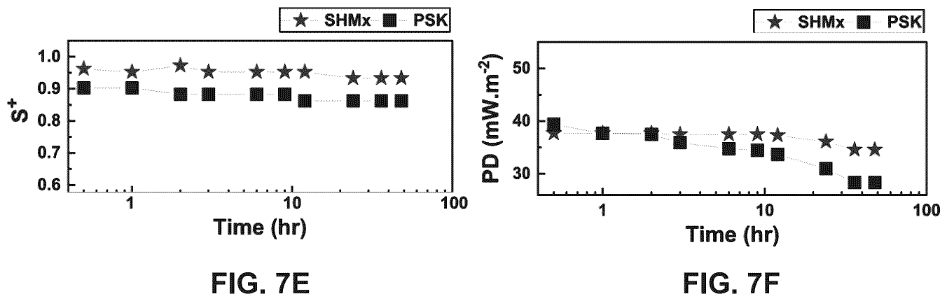

FIG. 7A illustrates cation selectivity of a SHMx hybrid membrane and PSK cation exchange membrane against ionic species with different hydrated diameters, according to some embodiments. The incorporation of MXene into SH membranes significantly enhanced the ion selectivity and transport properties. For example, the SHMx membrane demonstrated a pronounced preference for monovalent cations over divalent cations, exhibiting size-dependent steric sieving and electrostatic repulsion.

The SHMx demonstrated a greater dependence on the hydrated energy. The presence of MXene nanosheets within SHMx may have created a less hydrophilic environment, influencing the interaction between ions and the membrane. The hydrated radius and hydration energy of the ions played a more significant role in determining their transport through SHMx. Therefore, SHMx showed similar selectivity for Li⁺ and Na⁺ but lower selectivity for K⁺.

An increased binding affinity between counterions and fixed surface charges leads to counterion condensation, reducing mobile counterion concentrations within the membrane and affecting co-ion exclusion according to Donnan equilibrium. The lowered passage of K⁺ ions can be due to the creation of electrostatic barriers and increased hydrophobicity due to their condensation in channels. On the other hand, the transport of Lit ions possessing high hydration energy might be retarded due to the dielectric exclusion effect, resulting from the lower hydrophilic properties of the SHMX-fabricated nanocomposite membranes. On the other hand, the SHMx membranes showed higher rejection (or lower selectivity) for the divalent ion transport such as Mg²⁺ and Zn²⁺. These results show the dielectric exclusion effect, resulting from the enhanced hydrophobic properties of the fabricated SHMx nanocomposite membranes.

FIG. 7B illustrates the NaCl salinity gradient-dependent cation selectivity for a SHMx hybrid membrane and a PSK cation exchange membrane, according to some embodiments. Both membranes exhibited high cation selectivity, with SHMx demonstrating high cation selectivity of 0.99 up to 100-fold salinity gradients. SHMx maintained a relatively high cation selectivity even at higher salinity gradients (500-fold and 1000-fold). The surface charge control exerted by the MXene layers enhances the ionic conductivity of the SHMx membrane, particularly under low concentration conditions, leading to improved cation selectivity.

Furthermore, the electron double layer (EDL) length within nanochannels significantly impacts ion transport. When ion concentrations are low, the EDL length is comparable to or larger than the channel dimensions, allowing for EDL overlap. This overlap plays an important role in facilitating counterion transport and retarding coion transport within the nanochannels. At low ion concentrations, the charge density of the nanochannel walls becomes a dominant factor in ion transport. For example, surface diffusion, rather than bulk diffusion, can be the primary mechanism governing ion movement within the channels. The overlapping EDLs create a favorable environment for counterion transport while repelling coions.

FIG. 7C illustrates the current density for a SHMx hybrid membrane and a PSK cation exchange membrane in the presence of foulants, according to some embodiments. The ion permeation was examined under a binary system of NaCl salinity gradient of 50-fold in the presence of heavy metals with 20 ppm of Zn²⁺ or Ni²⁺ ions or organic compounds like phenol. Divalent cations such as Zn²⁺ and Ni²⁺, exhibited significantly suppressed transport behavior compared to Na⁺. This can be attributed to steric hindrance and partial dehydration, resulting from the larger hydrated ionic diameters and possible chemical adsorption onto the membrane surface. These factors led to a slight decline in ionic flux and cation selectivity. Additionally, the presence of foulants, such as phenol, can hinder the ion transport properties of the developed membranes. Phenol molecules can diffuse and adsorb onto the membrane surface through hydrogen bonding with the functional groups of the SHMx membranes. This interaction can decrease membrane conductance and ionic selectivity.

FIG. 7D illustrates resistivity across a SHMx hybrid membrane and a PSK cation exchange membrane in the presence of foulants, according to some embodiments. The presence of foulants, such as heavy metals and organic compounds, can significantly hinder the ion transport properties of certain membranes. However, SHMx membranes demonstrated high cation selectivity, even in the presence of these contaminants. This enhanced selectivity can be attributed to the properties of MXene, including its confined structure, and negative surface charge. These properties contribute to the retention of divalent ions with high hydration energy and the repulsion of organic compounds with a negative charge, such as phenol. While both membranes experienced a slight decline in current density and internal resistance in the presence of foulants, SHMx membranes exhibited a slightly higher current density compared to PSK. This is due to the lower internal resistance of SHMx membranes.

FIG. 7E illustrates long-term stability (cation selectivity) of a SHMx hybrid membrane and a PSK cation exchange membrane under a salinity gradient of 50-fold, according to some embodiments. FIG. 7F illustrates long-term stability (power density) of a SHMx hybrid membrane and a PSK cation exchange membrane under a salinity gradient of 50-fold, according to some embodiments. The incorporation of MXene into SH membranes significantly enhanced the ion selectivity and energy conversion efficiency. SHMx membranes exhibited power densities of 38.5 mW·m⁻².

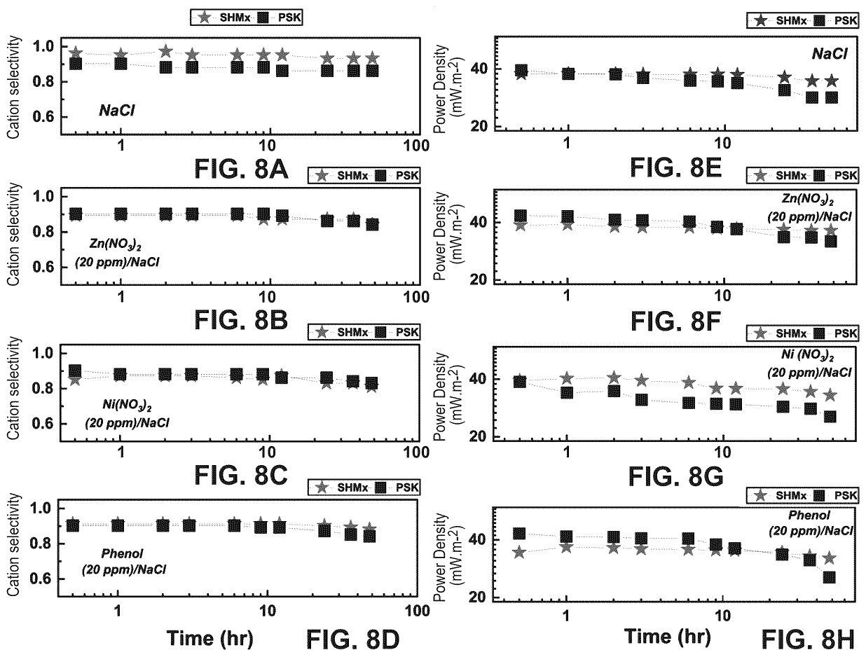

FIG. 8A illustrates long-term stability (cation selectivity) of the SHMx hybrid membranes compared to a PSK membrane, according to some embodiments. FIG. 8B illustrates long-term stability (cation selectivity) of the SHMx hybrid membranes compared to a PSK membrane, in the presence of Zn(NO₃)₂, according to some embodiments. FIG. 8C illustrates long-term stability (cation selectivity) of the SHMx hybrid membranes compared to a PSK membrane, in the presence of Ni(NO₃)₂, according to some embodiments. FIG. 8D illustrates long-term stability (cation selectivity) of the SHMx hybrid membranes compared to a PSK membrane, in the presence of phenol, according to some embodiments.

FIG. 8E illustrates long-term stability (power density) of the SHMx hybrid membranes compared to a PSK membrane, according to some embodiments. FIG. 8F illustrates long-term stability (power density) of the SHMx hybrid membranes compared to a PSK membrane, in the presence of Zn(NO₃)₂, according to some embodiments. FIG. 8G illustrates long-term stability (power density) of the SHMx hybrid membranes compared to a PSK membrane, in the presence of Ni(NO₃)₂, according to some embodiments. FIG. 8H illustrates long-term stability (power density) of the SHMx hybrid membranes compared to a PSK membrane, in the presence of phenol, according to some embodiments.

The SHMx membrane having enhanced cation selectivity and antifouling properties make it desirable for long-term applications in energy conversion and water treatment. The incorporation of MXene into SPES and SH membranes significantly enhanced the ion selectivity and transport properties. The synergistic effect of adding MXene and polymers with abundant functional groups like HA led to the development of hybrid membranes that demonstrated superior performance compared to PSK membranes in terms of ion selectivity and current density.

The incorporation of MXene into the SH membrane matrix (SHMx) significantly enhanced the conductivity and reduced resistance. The negatively charged hydroxyl groups on the MXene surface facilitated interactions with sodium ions, creating additional cation transport channels. This could increase the ionic conductivity due to the synergistic effects of the Grotthuss and vehicle mechanisms. The Grotthuss mechanism involves proton transfer through a hydrogen bond network, while the vehicle mechanism utilizes water molecules as carriers for cation diffusion. The substantially uniform dispersion of MXene nanosheets within the SH membranes promoted hydrogen bond formation, ionization, and deionization of conductive groups, contributing to faster cation transport and improved membrane performance.

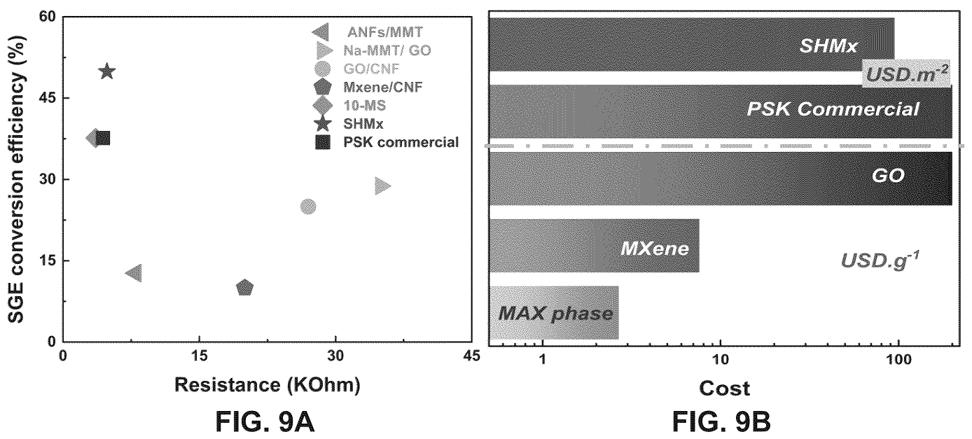

FIG. 9A illustrates a comparative plot of membrane resistivity and energy conversion efficiency of SHMx, a PSK cation exchange membrane, and other membranes, according to some embodiments. The comparison membranes were tested under the same salinity gradient (50-fold). These comparison membranes were prepared in a different way and with had different compositions. The developed membrane (SHMx) exhibited low ionic resistivity, and high energy conversion efficiency exceeding that of other composite membranes.

FIG. 9B illustrates unit cost of raw nanofiller materials per mass (g) or unit cost of membranes per 1 m² area, according to some embodiments. From the economic and environmental standpoints, the developed membranes offer several advantages compared to other membranes, such as the straightforward chemical controllability. Moreover, the cost advantage makes the SHMx membrane much more desirable. The material cost per unit weight of the prepared MXene is evaluated to 7.58 USD/g, which is 26 ten times cheaper than exfoliated graphene oxide (GO) materials of around 200 USD/g.

When it comes to membrane-scale evaluation, the estimated cost of the 1 m² SHMx nanocomposite membrane with a thickness of 16 μm is approximately 96.4 USD/m², which is two times less than that of other ion exchange membranes. Considering that the membrane fabrication process herein is scalable, the energy harvesting performances and cost feasibility of developed nanocomposite membranes make these membranes desirable for practical harnessing of energy from brine wastewater under varying salinity levels of monovalent and divalent ions. Furthermore, the membranes developed by incorporating HA and MXene offer significant advantages in ion selectivity, current density, operational stability, and resistance to fouling. These results highlight the usefulness for other applications in energy storage, water treatment, lithium recovery, and other fields requiring high-performance and selective ion exchange membranes.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A membrane, the membrane comprising:
sulfonated polyethersulfone;
humic acid; and
a MXene material,
wherein a weight ratio of humic acid to sulfonated polyethersulfone ranges from about 20:100 to about 30:100, and a weight ratio of the MXene material to sulfonated polyethersulfone ranges from about 15:100 to about 25:100.

2. The membrane of claim 1, wherein the MXene material includes a titanium-containing MXene.

3. The membrane of claim 1, wherein the MXene material includes a titanium carbide MXene.

4. The membrane of claim 1, wherein the weight ratio of humic acid to sulfonated polyethersulfone ranges from about 23:100 to about 27:100.

5. The membrane of claim 1, wherein the weight ratio of the MXene material to sulfonated polyethersulfone ranges from about 18:100 to about 22:100.

6. The membrane of claim 1, having intercalation of the humic acid and sulfonated polyethersulfone within layers of the MXene material.

7. The membrane of claim 1, wherein the membrane has an atomic percentage of Ti based on elemental composition ranging from about 0.1% to about 2%.

8. The membrane of claim 7, wherein the membrane has an atomic percentage of S based on elemental composition ranging from about 0.5% to about 3%.

9. A method for forming a membrane, the method comprising:
mixing a solvent, sulfonated polyethersulfone, and humic acid to form a first mixture;
adding a MXene material to the first mixture to form a second mixture;
casting the second mixture; and
evaporating the solvent to form a product membrane.

10. The method of claim 9, wherein the solvent includes N-methyl-2-pyrrolidone (NMP).

11. The method of claim 9, wherein a weight ratio of humic acid to sulfonated polyethersulfone in the product membrane ranges from about 20:100 to about 30:100.

12. The method of claim 9, wherein a weight ratio of the MXene material to sulfonated polyethersulfone in the product membrane ranges from about 15:100 to about 25:100.

13. The method of claim 9, wherein the product membrane exhibits intercalation of the humic acid and sulfonated polyethersulfone within layers of the MXene material.

14. The method of claim 9, wherein the MXene material includes a titanium carbide MXene.

15. A reverse electrodialysis system, the reverse electrodialysis system comprising:
an anode;
a cathode;
one or more anion exchange membranes; and
one or more cation exchange membranes, the one or more cation exchange membranes including a plurality of sulfonated polymers, humic acid, and a MXene material, wherein a weight ratio of humic acid to the plurality of sulfonated polymers in the one or more cation exchange membranes ranges from about 20:100 to about 30:100.

16. The reverse electrodialysis system of claim 15, wherein the weight ratio of humic acid to the plurality of sulfonated polymers in the one or more cation exchange membranes ranges from about 23:100 to about 27:100.

17. The reverse electrodialysis system of claim 15, wherein the plurality of sulfonated polymers includes sulfonated polyethersulfone, and a weight ratio of the MXene material to sulfonated polyethersulfone in the one or more cation exchange membranes ranges from about 15:100 to about 25:100.

18. The reverse electrodialysis system of claim 15, wherein the MXene material includes a titanium carbide MXene.

19. The reverse electrodialysis system of claim 15, wherein the one or more cation exchange membranes have an atomic percentage of Ti based on elemental composition ranging from about 0.1% to about 2%.

20. The reverse electrodialysis system of claim 15, wherein the one or more cation exchange membranes have an atomic percentage of S based on elemental composition ranging from about 0.5% to about 3%.
